(19) United States
(12) Patent Application Publication
(10) Pub. No.: US 2006/0188842 A1
(43) Pub. Date: Aug. 24, 2006

(54) Compression cap for tooth stumps and method of drying a tooth stump

(75) Inventors: Werner Mannschedel, Langenau (DE); Barbara Muller, Langenau (DE)

Correspondence Address: EDWARDS & ANGELL, LLP, P.O. BOX 55874, BOSTON, MA, 02205, US

(73) Assignee: Coltene/Whaledent GmbH & Co. KG, Langenau (DE)

(21) Appl. No.: 11/361,100

(22) Filed: Feb. 23, 2006

(30) Foreign Application Priority Data
Feb. 23, 2005 (DE) DE 102005008355.2

(51) Int. Cl. A61C 5/14

(52) U.S. Cl. 433/136

(57) ABSTRACT

Compression cap for tooth stumps and method of drying a tooth stump The present invention relates to a compression cap (1) for tooth stumps (5) and to a method of drying a tooth stump (5). The compression cap (1) for tooth stumps (5) has a hollow space (7) for receiving an absorbent foam mass (8) surrounding a tooth stump (5). The hollow space (7) has an opening (9) at one end for receiving the reagents (10, 11) for the foam mass (8) and for receiving the tooth stump (5) and is surrounded by walls whose wall thickness (d) is reduced in the direction towards the opening (9). The rim (14) at the opening has a spatial profile (15) of such a kind that the rim (14) at the opening constitutes a seal (16) when the compression cap (1 ) is in the state pressed against the interdental papilla (17) of a tooth stump (5) in the region of the gingival pocket (18) for the sulcus (19).

The present invention relates to a compression cap for tooth stumps, which comprises a material that is deformable and, optionally, absorbent in respect of body fluids. For the purpose, the compression cap has a hollow space for receiving a tooth stump.

Compression caps of such a kind are known under the trade name “Comprecap”. These compression caps serve for technical preparation of the taking of impressions of stumps of teeth. Before such an impression is taken, the surfaces of the stump of tooth and its surrounding area, especially the gingival pocket together with its sulcus, have to be freed from body fluid and dried. For that purpose, hitherto, a retraction cord containing an astringent styptic solution of 10% aluminium chloride hexahydrate has been wound around the tooth and pressed into the gingival pocket. The styptic agent of the soaked retraction cord does not give rise to any impairment of circulation and serves for pretreatment of the gingiva. By means of a retraction cord of such a kind, the sulcus of the gingival pocket is opened out and excess body fluid, such as blood and saliva, is drawn off.

The “Comprecap” is used as a technical aid to be guided with as close a fit as possible on the tooth stump in order to press the retraction cord as deeply as possible into the sulcus of the gingival pocket and to open out the gingival pocket. At the same time, the compression cap serves to dry the surfaces and to draw off body fluids in the area surrounding the tooth stump. In principle, the compression cap serves to push forward a cord, previously wound around the tooth stump, as far as the enamel-cement interface of the tooth stump. For that purpose it is necessary for the compression cap to fit as snugly as possible on the tooth stump in order for the retraction cord to be driven forward as far as the enamel-cement interface around the tooth.

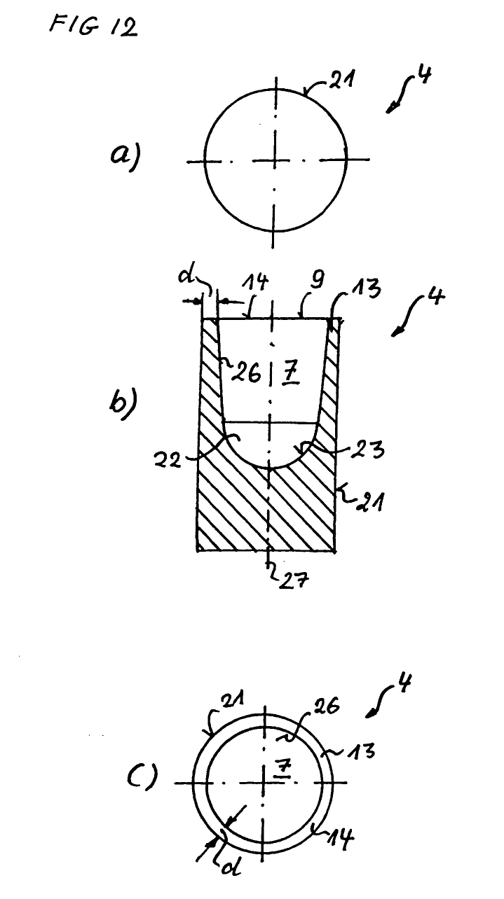

FIG. 12 shows an aid of such a kind in the form of a compression cap 4, with FIG. 12 a) showing a bottom view of the compression cap 4, FIG. 12 b) showing a longitudinal cross-section through the compression cap 4 and FIG. 12 c) showing a top view of the compression cap 4. Compression caps 4 of such a kind in the form of the so-called “Comprecap” are available in different sizes so that they can be matched to the different tooth stump volumes. The bottom view in FIG. 12 a) shows that the compression caps are cylindrical and FIG. 12 b) shows that the compression caps have a hollow space 7 which has a semi-circular internal contour 23 in the bottom region 22 and a slightly tapering inner wall 26, the wall thickness of which decreases in the direction towards the rim 14 at the opening. The rim 14 at the opening has a flat profile so that an even contact pressure on the retraction cord is possible over the circumference of the surface 14 at the opening. In FIG. 12 c) it can be seen that the rim 14 at the opening of the compression cap 4 according to the prior art is disc-shaped, the wall thickness in the region of the rim 14 at the opening being d, which is so selected that the rim at the opening can be introduced into the sulcus of the gingival pocket.

That compression cap has the disadvantage that it constitutes merely a technical tool for exerting a pressure on a retraction cord and, in so doing, opens out the sulcus to as wide an extent as possible before an impression of the tooth stump is taken. In the process it is found that the procedure both of applying the cord and of introducing the compression cap into the sulcus constitutes an extremely painful means of preparing for taking an impression of the tooth stump. Also, it is highly dependent on the skill of the person carrying out treatment, when introducing the retraction cord and when pressing the rim at the opening into the sulcus, as to the extent to which the sulcus itself is freed of body fluids. Accordingly, both the compression cap as such and also the procedure for drying tooth stumps and their surroundings are beset with considerable disadvantages.

There is accordingly a need to make possible more thorough drawing-off of body fluids in the area surrounding, and on, a tooth stump and, furthermore, a need to provide compression caps suitable for that purpose.

The problem of the invention is first to define a novel method for the preparation of the taking of impressions of tooth stumps and to provide a compression cap which has an improved design compared to hitherto available compression caps and which has a mode of construction functionally appropriate for the new method so that drying of tooth stumps and surrounding gingival pockets is made possible with expenditure of less time and using an improved tool in the form of a novel compression cap.

The problem is solved by the subject-matter of the independent claims. Advantageous developments of the invention are to be found in the dependent claims.

In accordance with the invention, there is provided a compression cap for tooth stumps which comprises a material that is deformable at room temperature. The compression cap according to the invention has a hollow space for receiving an absorbent and expanding plastics mass surrounding a tooth stump. The hollow space has an opening at one end for receiving the reagents for the expanding foam mass and for receiving the tooth stump and is surrounded by walls whose wall thickness reduces in the direction towards the opening. The rim at the opening has a spatial profile of such a kind that the rim at the opening constitutes a seal when the compression cap is in the state pressed against the interdental papilla of a tooth stump in the region of the gingival pocket for the sulcus.

This compression cap has the advantage firstly that the rim at its opening is not forced into the sulcus around the tooth stump but rather the profiled rim at its opening seals off the region around the tooth stump. It is accordingly possible to carry out an entirely new procedure, using this compression cap, for the drying and preparation of tooth stumps wherein it is no longer necessary, in order to expand the sulcus, for a retraction cord to be placed around the tooth in the sulcus using corresponding expansion tools. It is also no longer necessary subsequently to press a relatively blunt planar circumferential rim of a compression cap into the sulcus but rather the profiled rim at the opening can now be used to seal off the gingival pocket in order to expand the sulcus and to free it from body fluids by means of an expanding absorbent foam. The mode of operation and construction of the compression cap according to the invention accordingly differs markedly from the prior art and allows improved and more thorough drying of a tooth stump and its surrounding area, for example in preparation for an impression-taking procedure.

The compression cap preferably comprises, as deformable material, an elastomeric material. That elastomeric material comes to lie against the interdental papilla so as to form a seal and effectively seals off the hollow space of the compression cap from the oral cavity. As elastomeric material there is used, for example, a silicone.

In a preferred embodiment of the compression cap, it comprises, as deformable material, a material that simultaneously is absorbent. Preferably, for that purpose the compression cap comprises a compacted wadding capable of absorbing body fluids and/or a felt capable of absorbing body fluids and/or a foam capable of absorbing body fluids. Those materials have the advantage that in the region of the profiled rim at the opening they are sufficiently yielding to come to lie against the interdental papilla of the gingival pocket so as to form a seal. In addition, as a result of lying against the interdental papilla in that manner, the compression cap ensures that the hollow space is sealed off from the surrounding area so that the expanding foam mass formed from the reagents can spread around the tooth stump and reach deep within the sulcus.

For an advantageous embodiment of the invention, the compression cap comprises, as deformable material, a resilient material which is plastically deformable. A material of such a kind has the advantage that it is capable of adapting and yielding and fits snugly on the interdental papilla and ensures good sealing.

In a further preferred embodiment of the invention, the compression cap has a cylindrical external contour. The cylindrical external contour makes it possible to rotate the compression cap while it is being withdrawn. In the process, the absorbent and expanded foam mass, which because of the expansion of the foam and in some cases also because of the properties of the material of the compression cap has filtered into that material, is preferably also rotated together with the cap and can be simply withdrawn from the tooth stump.

In a further preferred embodiment, the compression cap has an elliptical cross-section. This cross-section can be intended for teeth of a particular shape but has the problem that rotation of this cap for removal of the foam from the surface of the tooth stump is hindered. In accordance with a further embodiment, the compression caps according to the invention can have flat surfaces at least on two sides located opposite one another so that a plurality of compression caps can be used next to one another. Furthermore, the compression cap can have a rectangular cross-section and have an outside that has smooth surfaces. This has the advantage that the compression cap can be handled in excellent manner and reliably positioned in the preparation phase in order, for example, for the starting materials for the foam mass to be reliably introduced into the hollow space.

In a further embodiment of the invention, the hollow space has a hemispherical internal contour in its bottom region. An internal contour of such a kind has the advantage that the hemisphere can already hold a first reagent of the absorbent expanding foam mass in the form of a gel or having some other consistency.

In a further embodiment of the invention, the walls have a cylindrical internal contour. A cylindrical internal contour of such a kind has the advantage that the wall thickness of the compression cap can be minimised and, as a result, made extremely small and thin.

In a further preferred embodiment of the invention, the compression cap has walls which have a parabolic internal contour. It is also possible in the case of the parabolic internal contour for a first reagent already to be deposited in the bottom region of the hollow space, which first reagent is then available for the reaction with a second reagent to form an expanding foam.

Furthermore it is possible for the walls to have a conical internal contour. A hemispherical or spherical cap-shaped bottom region for receiving a reagent can in turn follow on from that conical internal contour.

Furthermore it is possible for the walls to have an elliptical internal contour, in which case the internal contour constitutes just a half-ellipse so that the wall thickness of the compression cap decreases in the direction towards the rim at the opening.

The walls (13) preferably have a stepped internal contour. For that purpose, the steps of the internal contour can comprise portions of the cylindrical, parabolic, elliptical or conical internal contour in steps. This embodiment has the advantage that it can be closely matched to tooth stump shapes.

Furthermore it is possible for the wall thickness in the region of the opening to correspond to a tooth enamel thickness. When the wall thickness of the compression cap is so dimensioned, it is advantageous for the tooth stump to have been freed of tooth enamel and for the tooth stump to consist substantially of dentine.

Even though the rim at the opening is preferably disc-shaped, as in the case of customary compression caps, the profile of this disc shape is substantially modified by means of two oppositely located recesses, which fit snugly when pressed against the interdental papilla in the region of a gingival pocket between the rows of teeth. Those recesses in the rim at the opening preferably comprise, as spatial profile, a sector of a circle or a semi-circle. Accordingly, those regions of the spatial profile which do not constitute a recess can extend further over the gum than those regions which cover the interdental papilla between the teeth. This advantageously ensures the above-mentioned sealing and ensures that the compression cap is not pressed into the sulcus but rather the expanding foam first spreads out in the sulcus and then opens out the sulcus in order to effectively draw up all the body fluid of the gingival pocket and to dry the area surrounding the tooth stump and the tooth stump itself.

In addition, it is possible to provide a compression cap which comprises a plurality of hollow spaces located next to one another for a plurality of tooth stumps arranged next to one another for simultaneous drying thereof. A compression cap of such a kind has the advantage that it can be reliably handled, especially when drying a plurality of neighbouring tooth stumps. Finally it is also possible to provide a compression cap which comprises a row of hollow spaces located next to one another for a multiplicity of tooth stumps to be dried, partition walls being arranged between the hollow spaces and parting grooves being arranged between the partition walls in order to separate off individual compression caps, or a plurality of compression caps, from the multiplicity of hollow spaces arranged in a row, by making the desired separation of a limited number of or of individual compression caps along the parting grooves.

A method of drying a tooth stump and its surrounding area by means of a compression cap in accordance with the above statements comprises the following method steps. Firstly, a first reagent is deposited in the bottom region of the hollow space of the compression cap for the formation of an absorbent expanding plastics mass. The tooth stump is then wetted with a second reagent for the formation of the absorbent foam mass. Subsequently, the compression cap is applied by introducing the tooth stump into the hollow space of the compression cap. Then, the spatially profiled rim at the opening of the compression cap is pressed against the interdental papilla of the tooth stump in the region of the gingival pocket in order to seal off the sulcus. This can be done preferably by closing or pressing the rows of teeth against one another. When the tooth stump wetted with the second reagent is immersed in the first reagent in the bottom region of the hollow space of the compression cap, the absorbent and expanding foam mass is formed as a result of reaction of the two reagents. In the process, the foam mass penetrates into the sulcus of the gingival pocket. Body fluids are drawn up by the foam mass. Finally, the foam can be removed from the dried surfaces of the gingival pocket of the tooth stump by withdrawal of the compression cap together with adhering foam.

This method has the advantage that it can be carried out without causing great pain and within a reduced working time. The awkward wrapping-around of the tooth stump in the region of the sulcus and subsequent correspondingly painful pressing of the retraction cord into the sulcus by means of a customary compression cap are dispensed with entirely. Accordingly, pleasant fitting of the novel compression cap onto the gingiva of the area surrounding the tooth stump results in drying of the surfaces of the tooth stump and of the area surrounding it which is fast, reliable and which opens out the sulcus in pain-free manner.

A further preferred method of drying a tooth stump and its surrounding area by means of a compression cap comprises the following method steps:
deposition of a first reagent in a first chamber of a mixer and dispenser;
deposition of a second reagent in a second chamber of a mixer and dispenser;
mixing of the two reagents in a mixing chamber of the mixer;
dispensing an intended amount of the mixed reagents into a compression cap and/or onto a tooth stump;
application of the compression cap by introducing the tooth stump into the hollow space of the compression cap;
pressing of the spatially profiled rim at the opening of the compression cap against the interdental papilla of the tooth stump in the region of the gingival pocket for sealing off the sulcus;
formation of the absorbent foam mass from the mixed reagents;
penetration of the foam mass into the sulcus of the gingival pocket;
drawing-up of body fluids by the foam mass;
removal of the foam from the dried surfaces of the gingival pocket and the tooth stump by withdrawal of the compression cap with adhering foam.

This method has the advantage that, as a result of the use of the mixer with a dispenser, for example a double-chamber syringe having a static mixer, precise metering of the reagents being mixed can be carried out, before the compression cap comes into contact with the mixture.

A further alternative method of drying a tooth stump and its surrounding area by means of a compression cap comprises the following method steps:
deposition of a single-component foam, stored under cool conditions, in a dispenser;
dispensing an intended amount of the single-component foam into a compression cap;
application of the compression cap by introducing the tooth stump into the hollow space of the compression cap;
pressing of the spatially profiled rim at the opening of the compression cap against the interdental papilla of the tooth stump in the region of the gingival pocket for sealing off the sulcus;
formation of the absorbent foam mass from the single-component foam;
penetration of the foam mass into the sulcus of the gingival pocket;
drawing-up of body fluids by the foam mass;
removal of the foam from the dried surfaces of the gingival pocket and the tooth stump by withdrawal of the compression cap with adhering foam.

This method has the advantage that only on warming-up of the single-component foam does the material start to expand and the foam mass forms from the single-component foam as soon as the compression cap containing the single-component foam is pressed against the tooth stump or interdental papilla.

In a further method of drying a tooth stump and its surrounding area by means of a compression cap, the following method steps are provided:
deposition of a component, stored under cool conditions, of a single-component foam in a dispenser;
wetting of a tooth stump with the single-component foam from the dispenser;
application of the compression cap by introducing the tooth stump into the hollow space of the compression cap;
pressing of the spatially profiled rim at the opening of the compression cap against the interdental papilla of the tooth stump in the region of the gingival pocket for sealing off the sulcus;
formation of the absorbent foam mass from the single-component foam;
penetration of the foam mass into the sulcus of the gingival pocket;
drawing-up of body fluids by the foam mass;
removal of the foam from the dried surfaces of the gingival pocket and the tooth stump by withdrawal of the compression cap with adhering foam.

This method differs from the preceding method in that the compression cap is not filled with the single-component foam but rather the tooth stump is wetted therewith. Because the formation of the foam mass starts with wetting of the tooth stump, the compression cap must be set in place on the tooth stump within a short time.

In accordance with the invention, the foam in the above methods can also be both applied to the tooth stump and also introduced into the compression cap.

The invention will now be explained in greater detail with reference to the accompanying Figures.

FIG. 1 shows a first cross-section, in diagrammatic form, through a compression cap of a first embodiment of the invention;

FIG. 2 shows a second cross-section, in diagrammatic form, through the compression cap of FIG. 1 along the sectional plane A-A;

FIG. 3 shows a cross-section, in diagrammatic form, through a compression cap of a second embodiment of the invention;

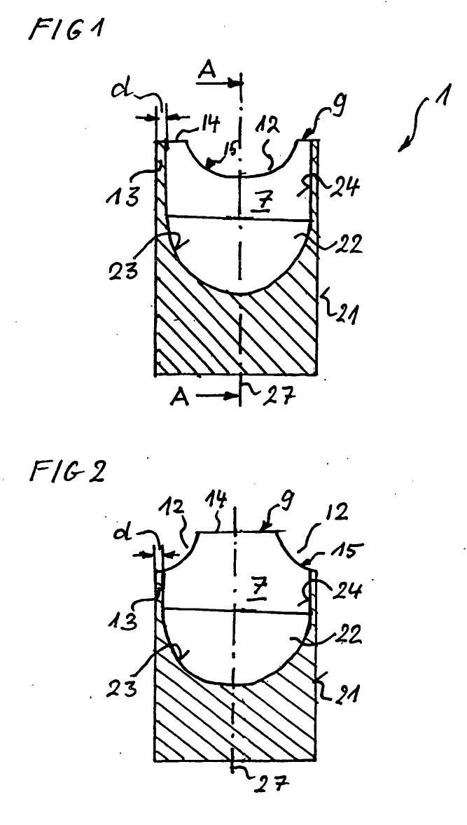

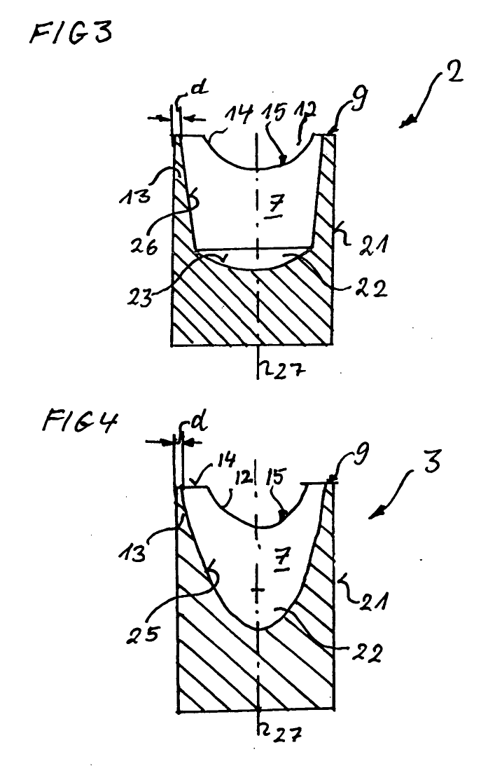

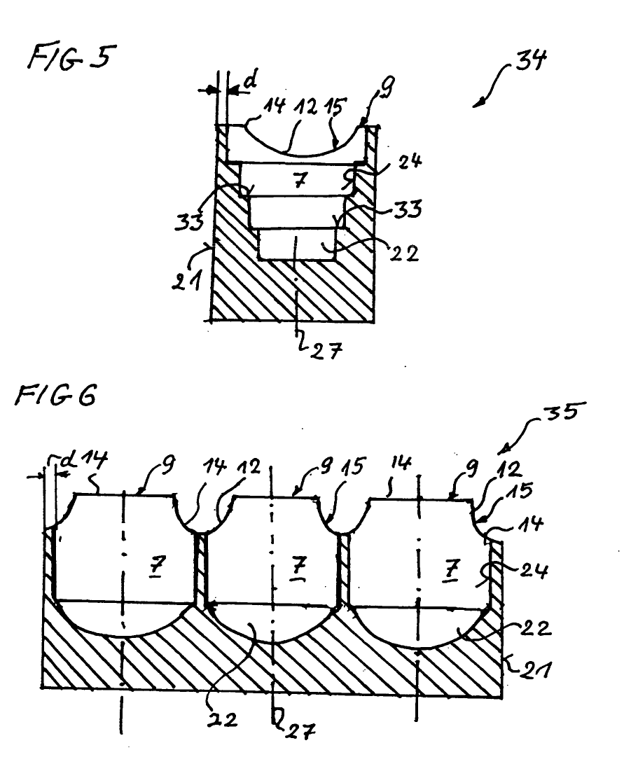

FIG. 4 shows a cross-section, in diagrammatic form, through a compression cap of a third embodiment of the invention;

FIG. 5 shows a cross-section, in diagrammatic form, through a compression cap of a fourth embodiment of the invention;

FIG. 6 shows a cross-section, in diagrammatic form, through a compression cap of a fifth embodiment of the invention;

FIGS. 7 to 10 show method steps in the drying of a tooth stump and its surrounding area;

FIG. 7 shows a cross-section, in diagrammatic form, through a dentine tooth stump with the surrounding rim of a gingival pocket;

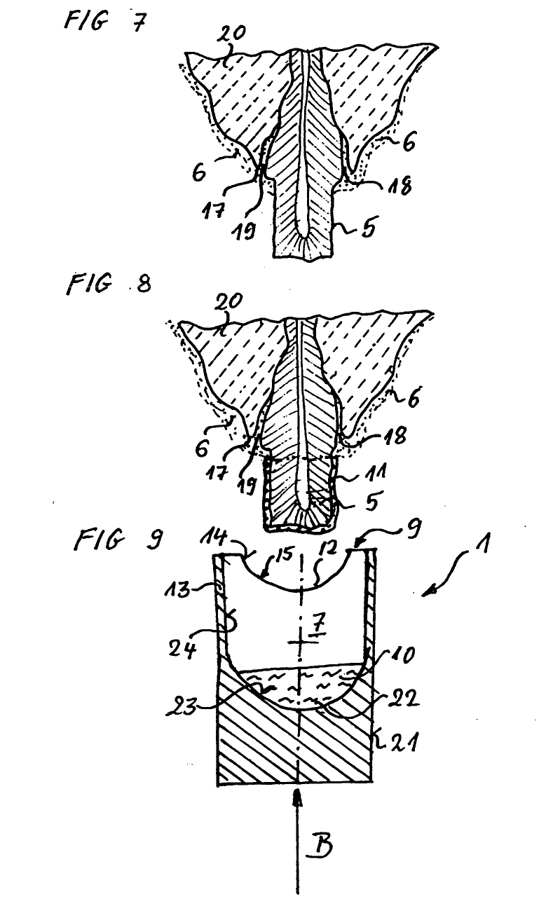

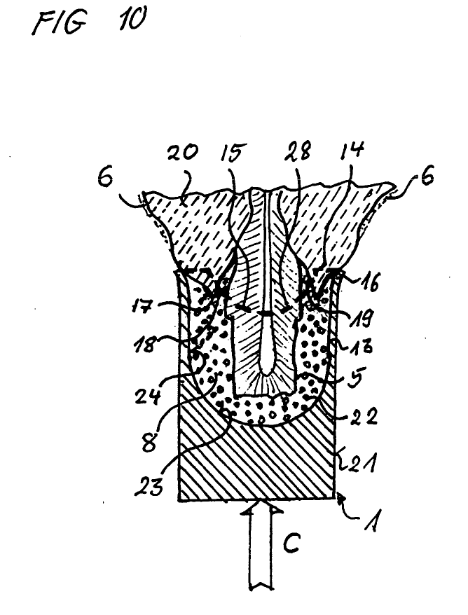

FIG. 8 shows a cross-section, in diagrammatic form, through the dentine tooth stump according to FIG. 7 after wetting the tooth stump with a reagent;

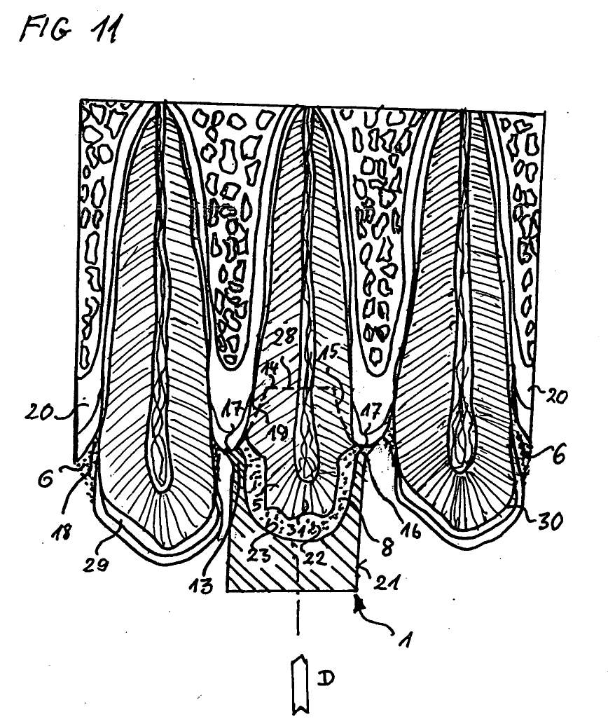

FIG. 9 shows a cross-section, in diagrammatic form, through a compression cap after introduction of a reagent;

FIG. 10 shows a cross-section, in diagrammatic form, through the compression cap after formation of an absorbent expanding foam mass embedding the tooth stump;

FIG. 11 shows a cross-section, in diagrammatic form, through three adjacent teeth comprising a central tooth stump, which is embedded in an absorbent foam mass inside a compression cap;

FIG. 12 shows a cap according to the prior art.

FIG. 1 shows a first cross-section, in diagrammatic form, through a compression cap 1 of a first embodiment of the invention. The compression cap 1 has a cylindrical external contour 21 and is made from a compacted wadding. The compression cap 1 has a hollow space 7, which is accessible from the top through an opening 9. The hollow space 7 is surrounded by walls 13, which have a cylindrical internal contour 24 and, in the bottom region 22, a transition to a hemispherical shape. A rim 14 at the opening 9 has a spatial profile 15 which is provided with two recesses 12 located opposite one another and which, by virtue of those recesses 12, can spatially adapt to an interdental papilla of a tooth stump in the region of the gingival pocket to form a seal when the compression cap 1 is pressed thereagainst.

FIG. 2 shows a second cross-section, in diagrammatic form, through the compression cap 1 of FIG. 1 along the sectional plane A-A. In that second cross-section in diagrammatic form, the profile 15 of the rim at the opening 9 becomes clear, the recess 12 in the shape of a sector of a circle shown in FIG. 1 here being arranged on both sides of the mid-line 27 of the compression cap 1. That profiled arrangement of the rim at the opening 9 results in its being possible for the compression cap 1 to be pushed further over the tooth stump than is possible in the case of the compression cap 4 according to the prior art shown in FIG. 12. This also results in the fact that, for the first time, the compression cap 1 is not to be used for pushing in a retraction cord but rather performs a sealing function around a tooth stump to be dried and sealed. Components having the same functions as in FIG. 1 are referred to by the same reference symbols and are not separately discussed in the subsequent Figures.

FIG. 3 shows a cross-section, in diagrammatic form, through a compression cap 2 of a second embodiment of the invention. In this second embodiment of the invention, a conical internal wall contour 26 is produced for the walls 13 of the hollow space 7, which has the advantage that the walls in the region of the opening 9 have a minimal wall thickness d, which becomes larger in the direction towards the bottom region 22 and accordingly makes possible in this case as in the previous case gentle adaptation of the rim 14 at the opening to the contour of the interdental papilla, whereas the lower region can exert an increased contact pressure on the interdental papilla, without the walls 13 in the lower region and in the immediate vicinity of the bottom region 22 being greatly deformed.

FIG. 4 shows a cross-section, in diagrammatic form, through a compression cap 3 of a third embodiment of the invention. In this embodiment of the invention, the wall thickness d increases in the direction towards the bottom region as a result of a parabolic internal contour 25 of the hollow space 7.

FIG. 5 shows a cross-section, in diagrammatic form, through a compression cap 34 of a fourth embodiment of the invention. Components having the same functions as in the preceding Figures are referred to by the same reference symbols and are not separately discussed. The fourth embodiment of the invention differs from the preceding embodiments in that the walls (13) have a stepped internal contour comprising steps 32 which are matched to the tooth stump.

FIG. 6 shows a cross-section, in diagrammatic form, through a compression cap 35 of a fifth embodiment of the invention. Components having the same functions as in the preceding Figures are referred to by the same reference symbols and are not separately discussed. The fifth embodiment of the invention differs from the preceding embodiments in that the compression cap has a plurality of hollow spaces 7 located next to one another for a plurality of tooth stumps arranged next to one another for simultaneous tooth stump drying. A compression cap of such a kind can be so extended that the compression cap has a row of hollow spaces 7 located next to one another for a multiplicity of tooth stumps to be dried, in which case partition walls 32 are arranged between the hollow spaces 7 and parting grooves are arranged between the partition walls in order to separate off individual compression caps, or a plurality of compression caps, from the multiplicity of hollow spaces arranged in a row.

FIGS. 7 to 10 show method steps in the drying of a tooth stump 5 and its surrounding area. For that purpose, FIG. 7 shows a cross-section, in diagrammatic form, through a dentine tooth stump 5 with the surrounding rim of a gingival pocket 18, which is formed by an interdental papilla 17 and which forms a sulcus 19 between the tooth stump 5 and the gingiva 20. That gap or sulcus 19 and also the surface of the gingiva 20 are usually covered with body fluid 6, which can comprise saliva and traces of blood. Using the following illustrations it will now be shown how those regions around the tooth stump 5 can be dried with the aid of the compression cap according to the invention.

For the purpose, FIG. 8 shows a cross-section, in diagrammatic form, through the dentine tooth stump 5 according to FIG. 7 after wetting the tooth stump 5 with a reagent 11. That reagent 11 can also be applied solely to the end of the tooth stump 5 or it can, immediately prior to the bringing together of the compression cap 1 shown in FIG. 9 and the tooth stump 5, also be dripped into the hollow space 7 of the compression cap 1 of FIG. 9 independently of the tooth stump 5 if wetting of the tooth stump 5 with the reagent 11 of an absorbent and expanding foam mass is not possible.

FIG. 9 shows a cross-section, in diagrammatic form, through a compression cap 1 after introduction of a reagent 10. This reagent 10 is a further reagent which is necessary in order to trigger a foam-forming reaction when in contact with the reagent 11. That reagent 10 is therefore arranged in gel form in the bottom region 22 of the compression cap 1, which bottom region 22 has a hemispherical internal contour 23. The gel form of the reagent 10 prevents the material of the compression cap 1 from absorbing the reagent 10. After the bottom region 22 has been filled with reagent 10, the compression cap 1 can then be pushed onto the tooth stump 5 shown in FIG. 8 in the direction of arrow B, whereupon the profiled rim 9 adapts to the shape of the gingiva 20 surrounding the tooth stump 5, to form a seal.

FIG. 10 shows a cross-section, in diagrammatic form, through the compression cap 1 after formation of an absorbent expanding foam mass 8 embedding the tooth stump 5. Because of the expanding property of the foam mass 8, which arises as a result of bringing together the reagents 10 and 1 1 shown in FIGS. 8 and 9, the sulcus 19 of the gingival pocket 18 is simultaneously opened out and thoroughly filled with foam mass 8, whereupon the body fluids 6 are taken up as a result of the absorbent property of that foam mass 8. In the process, a seal 16 is created as a result of the rim 14 at the opening being formed in accordance with the invention, which seal 16 rests on the interdental papilla 17 and seals off the gingival pocket 18 together with the sulcus 19. The broken line 28 therein represents the outline of the spatial profile 15 of the rim 14 at the opening of the compression cap 1 in its original shape. That original shape becomes distorted slightly as a result of pressure in the direction of arrow C and formation of the seal 16.

FIG. 11 shows a cross-section, in diagrammatic form, through three adjacent teeth 29, 30 and 31, the middle tooth 31 comprising a tooth stump 5, which is embedded in an expanding foam mass 8 inside the compression cap 1, which foam mass 8 dries the surfaces of the tooth stump 5 and opens out the sulcus 19. The broken line 28 again shows the original spatial profile 15 of the rim 14 at the opening, which profile 15 forms a seal 16 on the interdental papilla 17. Whereas, during embedding of the tooth stump 5 in the foam mass 8, the compression cap 1 is pressed in the direction of arrow D to form the seal 16, it is possible, after formation of the expanding and absorbent foam mass 8, for that foam mass 8 to be removed from the tooth stump 5 together with the absorbed body fluid so that a dry tooth stump is available for further treatment, for example the taking of an impression. The broken line 28 clearly shows that, as a result of the spatially profiled rim 14 at the opening, the gingiva 20 is covered over further towards the palate region and towards the frontal region than in the region of the interdental papilla 17 and consequently a sealing effect all the way around the tooth stump 5 is achieved using the compression cap 1 according to the invention.

### LIST OF REFERENCE SYMBOLS

1 compression cap (first embodiment)
2 compression cap (second embodiment)
3 compression cap (third embodiment)
4 compression cap (according to the prior art)
5 tooth stump
6 body fluid
7 hollow space
8 foam mass
9 opening of the hollow space
10 first reagent
11 second reagent
12 recess in the rim at the opening
13 walls of the hollow space
14 rim at the opening
15 profile of the rim at the opening
16 seal
17 interdental papilla
18 gingival pocket
19 sulcus
20 gingiva
21 external contour
22 bottom region of the hollow space
23 hemispherical internal contour
24 cylindrical internal contour
25 parabolic internal contour
26 conical internal contour
27 mid-line
28 broken line
29 tooth
30 tooth
31 tooth
32 partition wall
33 step
34 compression cap (fourth embodiment)
35 compression cap (fifth embodiment)
d wall thickness of the walls of the hollow space
A-A sectional plane

1-20. (canceled)

21. A compression cap for tooth stumps, comprising:
a hollow space for receiving an absorbent foam mass surrounding a tooth stump, and the hollow space comprising an opening at one end for receiving the reagents for the foam mass and for receiving the tooth stump, and
the hollow space being surrounded by walls whose wall thickness is reduced in the direction towards the opening, and
the rim at the opening having a spatial profile of such a kind that the rim at the opening constitutes a seal when the compression cap is in the state pressed against the interdental papilla of a tooth stump in the region of the gingival pocket for the sulcus.

22. The compression cap of claim 21 wherein the compression cap comprises an elastomeric material.

23. The compression cap of claim 21 wherein the compression cap comprises silicone.

24. The compression cap of claim 21 wherein the compression cap comprises a compressible material.

25. The compression cap of claim 24 wherein the compressible material comprises a compacted wadding capable of absorbing body fluids and/or a felt capable of absorbing body fluids and/or a foam capable of absorbing body fluids.

26. The compression cap of claim 21 wherein the compression cap comprises a soft resilient material which is plastically deformable.

27. The compression cap of claim 21 wherein the compression cap has a cylindrical external contour.

28. A compression cap of claim 21 wherein the compression cap has an elliptical cross-section.

29. A compression cap of claim 21 wherein the compression cap has a rectangular cross-section and an outside that has smooth surfaces.

30. A compression cap of claim 21 wherein the hollow space has a hemispherical internal contour in the bottom region.

31. A compression cap of claim 21 wherein the walls have a cylindrical internal contour.

32. A compression cap of claim 21 wherein the walls have a parabolic internal contour.

33. A compression cap of claim 21 wherein the walls have a conical internal contour.

34. A compression cap of claim 21 wherein the walls have an elliptical internal contour.

35. A compression cap of claim 21 wherein the walls have a stepped internal contour.

36. A compression cap of claim 21 wherein the wall thickness in the region of the opening corresponds to a tooth enamel thickness.

37. A compression cap of claim 21 wherein the rim at the opening is disc-shaped and has, in the profile, two oppositely located recesses, which fit snugly when pressed against the interdental papilla in the region of a gingival pocket.

38. A compression cap of claim 37 wherein each of the oppositely located recesses in the rim at the opening comprises, as spatial profile, a sector of a circle.

39. A compression cap of claim 21 wherein the compression cap comprises a plurality of hollow spaces located next to one another for a plurality of tooth stumps arranged next to one another for simultaneous drying.

40. A compression cap of claim 37 wherein the compression cap comprises a row of hollow spaces located next to one another for a multiplicity of tooth stumps to be dried, partition walls being arranged between the hollow spaces and parting grooves being arranged between the partition walls in order to separate off individual compression caps, or a plurality of compression caps, from the multiplicity of hollow spaces arranged in a row.

41. A method of drying a tooth stump and its surrounding area with a compression cap, the method comprising:
deposition of a first reagent in a first chamber of a mixer and dispenser;
deposition of a second reagent in a second chamber of a mixer and dispenser;
mixing of the two reagents in a mixing chamber of the mixer;
dispensing an intended amount of the mixed reagents into a compression cap and/or onto a tooth stump;
application of the compression cap by introducing the tooth stump into the hollow space of the compression cap;
pressing of the spatially profiled rim at the opening of the compression cap against the interdental papilla of the tooth stump in the region of the gingival pocket for sealing off the sulcus;
formation of the absorbent foam mass from the mixed reagents;
drawing-up of body fluids by the foam mass; and
removal of the foam by withdrawal of the compression cap with adhering foam.

42. The method of claim 41 wherein the produced compression cap comprises a hollow space for receiving an absorbent foam mass surrounding a tooth stump, and the hollow space comprising an opening at one end for receiving the reagents for the foam mass and for receiving the tooth stump; and the hollow space being surrounded by walls whose wall thickness is reduced in the direction towards the opening; and the rim at the opening having a spatial profile of such a kind that the rim at the opening constitutes a seal when the compression cap is in the state pressed against the interdental papilla of a tooth stump in the region of the gingival pocket for the sulcus.

43. A method of drying a tooth stump and its surrounding area, the method comprising:
deposition of a component, stored under cool conditions, of a single-component foam in a dispenser;
dispensing an intended amount of the single-component foam into a compression cap and/or onto a tooth stump;
application of the compression cap by introducing the tooth stump into the hollow space of the compression cap;
pressing of the spatially profiled rim at the opening of the compression cap against the interdental papilla of the tooth stump in the region of the gingival pocket for sealing off the sulcus;
formation of the absorbent foam mass from the single-component foam;
drawing-up of body fluids by the foam mass; and
removal of the foam by withdrawal of the compression cap with adhering foam.

44. The method of claim 43 wherein the produced compression cap comprises a hollow space for receiving an absorbent foam mass surrounding a tooth stump, and the hollow space comprising an opening at one end for receiving the reagents for the foam mass and for receiving the tooth stump; and the hollow space being surrounded by walls whose wall thickness is reduced in the direction towards the opening; and the rim at the opening having a spatial profile of such a kind that the rim at the opening constitutes a seal when the compression cap is in the state pressed against the interdental papilla of a tooth stump in the region of the gingival pocket for the sulcus.
